(19) United States
(12) Patent Application Publication
(10) Pub. No.: US 2019/0226496 A1
(43) Pub. Date: Jul. 25, 2019

(54) TURBOCHARGER

(71) Applicant: KABUSHIKI KAISHA TOYOTA JIDOSHOKKI, Aichi-ken (JP)

(72) Inventors: Tatsuya ARAKAWA, Aichi-ken (JP); Tsuyoshi UESUGI, Aichi-ken (JP); Shota TANAKA, Aichi-ken (JP)

(73) Assignee: KABUSHIKI KAISHA TOYOTA JIDOSHOKKI, Aichi-ken (JP)

(21) Appl. No.: 16/252,999

(22) Filed: Jan. 21, 2019

(30) Foreign Application Priority Data
Jan. 23, 2018 (JP) 2018-008860

(51) Int. Cl. F04D 29/58; F02B 37/00; F04D 27/02; F04D 29/05; F04D 29/44; F04D 29/66; F02B 39/08

(52) U.S. Cl. CPC F04D 29/5826; F02B 37/00; F04D 27/023; F04D 29/05; F02B 2037/125; F04D 29/44; F04D 29/667; F02B 39/08; F04D 29/5853

(57) ABSTRACT

A turbocharger includes a compressor housing, a compressor impeller, a diffuser passage, a diffuser surface, a cooling passage, and a return passage. The diffuser surface is a part of the compressor housing and is a wall surface of the compressor housing that faces the diffuser passage. A part of an intake gas returns through the return passage to an upstream side of the compressor impeller in a flow direction of the intake gas in the compressor housing. A passage forming member is attached to the compressor housing, and cooperates with the compressor housing to form the return passage. The compressor housing has an insertion recess that has a circular shape. The insertion recess receives an insertion portion that is a part of the passage forming member and has a cylindrical shape. The cooling passage is formed by the insertion recess and the insertion portion inserted into the insertion recess.

### CROSS REFERENCE TO RELATED APPLICATIONS

The present application claims priority to Japanese Patent Application No. 2018-008860 filed on Jan. 23, 2018, the entire disclosure of which is incorporated herein by reference.

### BACKGROUND ART

The present disclosure relates to a turbocharger.

A turbocharger includes a turbine impeller and a compressor impeller. The turbine impeller is rotated by exhaust gas emitted from an internal combustion engine. The compressor impeller is rotated integrally with the turbine impeller via an impeller shaft that is coupled to the compressor impeller and the turbine impeller at opposite ends of the impeller shaft. The rotation of the compressor impeller compresses intake gas that is introduced to a compressor housing. The compressed intake gas flows through a diffuser passage that extends annularly to surround the compressor impeller. The velocity of the compressed intake gas is slowed and converted into the pressure energy in the diffuser passage. The highly-compressed intake gas is discharged to a scroll passage and delivered to the internal combustion engine. This increases the intake efficiency and the performance of the engine.

In the compressor housing, a diffuser surface is a wall surface that faces the diffuser passage, and is heated by the intake gas, which is highly compressed by the rotation of the compressor impeller, flowing through the diffuser passage. For example, if the intake gas contains oil, the oil may coke on the diffuser surface and may be built up in the diffuser passage. The built up coked oil may reduce a section area of the diffuser passage and may block the delivery of the intake gas to the engine by the turbocharger.

For example, a turbocharger mentioned in Japanese Patent No. 5359403 has a cooling passage in a compressor housing to cool a diffuser surface by flowing fluid in the cooling passage. This configuration suppresses heating of the diffuser surface and coking of oil on the diffuser surface.

In case that a flow rate of the intake gas introduced to the compressor housing in the turbocharger decreases, the decreasing flow rate may cause the intake gas to flow back, which results in surging. The surging may disable the turbocharger. To solve this problem, for example, in Japanese Patent Application Publication No. 2013-224584, a part of the intake gas, which is introduced by the rotation of a compressor impeller, is returned to the upstream side of the compressor impeller in a flow direction of the intake gas in a compressor housing. This reduces occurrence of surging even if the flow rate of the intake gas introduced to the compressor housing decreases, thereby increasing the operation area of the turbocharger in a state that the flow rate of the intake gas introduced to the compressor housing is low.

However, the cooling passage mentioned in Japanese Patent No. 5359403 is formed within a wall portion of the compressor housing. Such a structure of the compressor housing needs to be formed in a complex mold using a core cylinder. Accordingly, making the cooling passage within the wall portion of the compressor housing takes additional work and man-hours.

The present disclosure is directed to providing a turbocharger that reduces occurrence of surging and facilitates making of a cooling passage.

### SUMMARY

In accordance with an aspect of the present disclosure, there is provided a turbocharger that includes a compressor housing, a compressor impeller, a diffuser passage, a diffuser surface, a cooling passage, and a return passage. The compressor housing is configured to receive an intake gas to be delivered to an internal combustion engine. The compressor impeller is accommodated in the compressor housing and configured to compress the intake gas. The intake gas compressed by the compressor impeller flows through the diffuser passage. The diffuser passage extends annularly to surround the compressor impeller. The diffuser surface is a part of the compressor housing. The diffuser surface is a wall surface of the compressor housing that faces the diffuser passage. A fluid for cooling the diffuser surface flows through the cooling passage. A part of the intake gas returns through the return passage to an upstream side of the compressor impeller in a flow direction of the intake gas in the compressor housing. A passage forming member is attached to the compressor housing, and cooperates with the compressor housing to form the return passage. The compressor housing has an insertion recess that has a circular shape. The insertion recess receives an insertion portion that is a part of the passage forming member and has a cylindrical shape. The cooling passage is formed by the insertion recess and the insertion portion inserted into the insertion recess.

Other aspects and advantages of the present disclosure will become apparent from the following description, taken in conjunction with the accompanying drawings, illustrating by way of example the principles of the disclosure.

### BRIEF DESCRIPTION OF THE DRAWINGS

The present disclosure together with objects and advantages thereof, may best be understood by reference to the following description of the embodiments together with the accompanying drawings in which:

FIG. 1 is a sectional side view of a turbocharger according to an embodiment;

FIG. 2 is a partially enlarged sectional side view of the turbocharger;

FIG. 3 is an enlarged sectional view of a vicinity of a cooling passage;

FIG. 4 is a partial perspective view of a compressor housing;

FIG. 5 is a perspective view of a covering member;

FIG. 6 is a partial front view of the compressor housing;

FIG. 7 is an exploded sectional view of the compressor housing, a ring member, and the covering member;

FIG. 8 is a partially enlarged front view of the compressor housing;

FIG. 9 is a front view of the covering member;

FIG. 10 is an enlarged front view of a vicinity of a falling prevention portion;

FIG. 11 is a partially enlarged sectional side view of a turbocharger according to another embodiment; and

FIG. 12 is an exploded sectional view of a compressor housing and a covering member of FIG. 11.

### DETAILED DESCRIPTION OF THE EMBODIMENTS

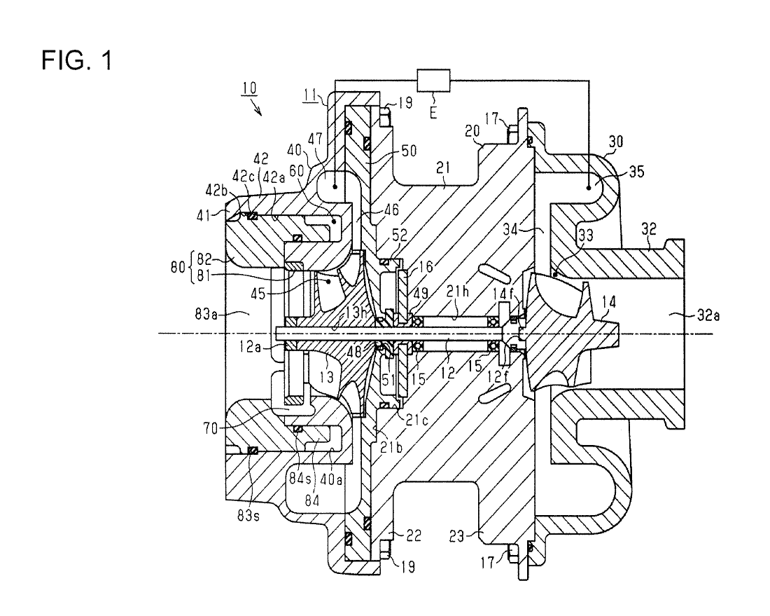

The following will describe a turbocharger according to an embodiment of the present disclosure with reference to FIGS. 1 through 10. FIG. 1 depicts a turbocharger 10 that includes a housing 11. The housing 11 includes a bearing housing 20, a turbine housing 30, and a compressor housing 40. The compressor housing 40 is configured to receive an intake gas to be delivered to an internal combustion engine E. The turbine housing 30 is configured to receive an exhaust gas that is emitted from the internal combustion engine E.

The bearing housing 20 supports an impeller shaft 12 rotatably. A first end of the impeller shaft 12 is coupled to a compressor impeller 13. A second end of the impeller shaft 12 is coupled to a turbine impeller 14.

A sealing plate 50 is disposed between the compressor housing 40 and the first end of the impeller shaft 12 supported by the bearing housing 20. That is, the compressor housing 40 is coupled, via the sealing plate 50, to the first end of the impeller shaft 12 that is supported by the bearing housing 20. The turbine housing 30 is coupled to the second end of the impeller shaft 12 supported by the bearing housing 20.

The bearing housing 20 includes a main body 21 having a cylindrical shape. The main body 21 has an insertion hole 21h through which the impeller shaft 12 is inserted. The impeller shaft 12 inserted through the insertion hole 21h is rotatably supported by the main body 21 via a radial bearing 15. An axial direction of the main body 21 corresponds to an axial direction of the impeller shaft 12.

The main body 21 has a depression 21c that has a round hole shape. The depression 21c is formed in an end face 21b of a first end of the main body 21 that is oriented to the first end of the impeller shaft 12. The insertion hole 21h opens on a bottom surface of the depression 21c. A diameter of the depression 21c is larger than a diameter of the insertion hole 21h. An axis of the depression 21c corresponds to an axis of the insertion hole 21h. The depression 21c accommodates a thrust bearing 16. The thrust bearing 16 is accommodated in the depression 21c in contact with the bottom surface of the depression 21c.

The bearing housing 20 includes a first flange 22 and a second flange 23. The first flange 22 projects outwardly in a radial direction of the impeller shaft 12 from an outer peripheral surface of the main body 21 at the first end of the main body 21. The second flange 23 projects outwardly in the radial direction of the impeller shaft 12 from an outer peripheral surface of the main body 21 at a second end of the main body 21. Each of the first flange 22 and the second flange 23 has a ring shape.

The turbine housing 30 is mounted to the second flange 23 by a plurality of screws 17. The turbine housing 30 includes a cylindrical portion 32. The cylindrical portion 32 has an exhaust gas outlet 32a. The exhaust gas outlet 32a extends in the axial direction of the impeller shaft 12 inside the cylindrical portion 32. An axis of the exhaust gas outlet 32a corresponds to the axis of the impeller shaft 12.

The turbine housing 30 has a turbine chamber 33, a communication passage 34, and a turbine scroll passage 35. The turbine impeller 14 is accommodated in the turbine chamber 33. The turbine scroll passage 35 extends in such a whirl as to extend around an outer periphery of the turbine chamber 33. Thus, the turbine scroll passage 35 surrounds the turbine chamber 33. The exhaust gas emitted from the internal combustion engine E flows through the turbine scroll passage 35. The communication passage 34 extends annularly in a form of a loop around the turbine chamber 33. The turbine chamber 33 is in communication with the turbine scroll passage 35 through the communication passage 34, and also in communication with the exhaust gas outlet 32a. The turbine chamber 33 directs the exhaust gas from the turbine scroll passage 35 to the exhaust gas outlet 32a.

The turbine impeller 14 includes a projected fitting portion 14f that projects toward the insertion hole 21h. The impeller shaft 12 has a recessed fitting portion 12f for receiving the projected fitting portion 14f. The recessed fitting portion 12f is formed in an end face of the second end of the impeller shaft 12. The turbine impeller 14 is mounted to the impeller shaft 12, for example, by welding, such that the turbine impeller 14 is rotatable integrally with the impeller shaft 12 with the projected fitting portion 14f fitted in the recessed fitting portion 12f. The turbine impeller 14 is rotated by the exhaust gas that flows into the turbine chamber 33. The impeller shaft 12 is rotated integrally with the turbine impeller 14.

The sealing plate 50 has an insertion hole 51 through which the impeller shaft 12 is inserted. The insertion hole 51 is formed through a surface of the sealing plate 50 that faces away from the compressor housing 40. The sealing plate 50 includes a cylindrical insertion portion 52 that has a cylindrical shape and protrudes from around the insertion hole 51. The cylindrical insertion portion 52 is inserted into the depression 21c. The thrust bearing 16 is disposed between the cylindrical insertion portion 52 and a bottom surface of the depression 21c in the axial direction of the impeller shaft 12, and is located inward of the cylindrical insertion portion 52 in the radial direction of the impeller shaft 12.

The compressor housing 40 has a bottomed-cylindrical shape. The compressor housing 40 is coupled to the first end of the impeller shaft 12 by a plurality of screws 19. The screws 19 are screwed in the compressor housing 40 through the first flange 22 and the sealing plate 50 such that the sealing plate 50 is interposed between the bearing housing 20 and an open end of the compressor housing 40 that opens to the bearing housing 20. The opening of the compressor housing 40 is closed by the sealing plate 50.

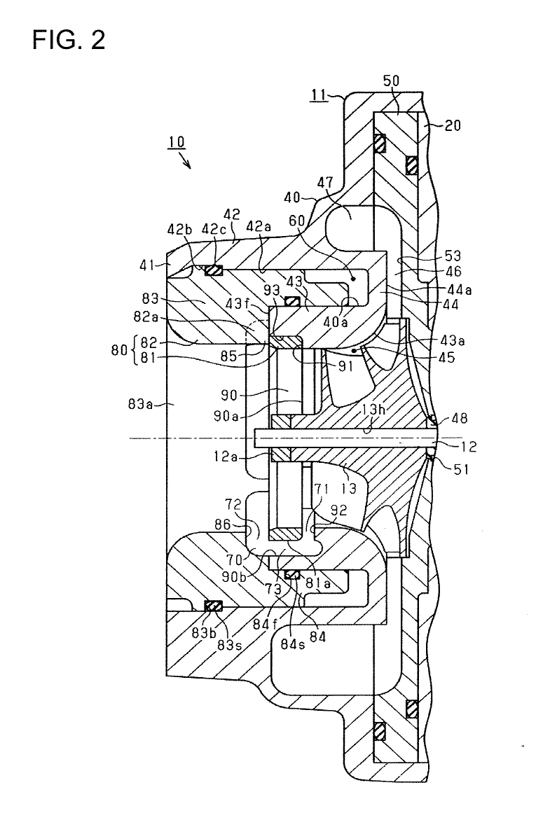

As shown in FIG. 2, the compressor housing 40 includes a cylindrical portion 42. The cylindrical portion 42 has a cylindrical shape and projects to the opposite side of the open end of the compressor housing 40. The compressor housing 40 further includes a shroud portion 43 that has a cylindrical shape and is located inside the cylindrical portion 42. An axis of the cylindrical portion 42 corresponds to an axis of the shroud portion 43. The axis of the cylindrical portion 42 and the axis of the shroud portion 43 correspond to the axial direction of the impeller shaft 12. In this embodiment, the compressor housing 40 is an aluminum die-cast part.

The cylindrical portion 42 of the compressor housing 40 includes a small diameter portion 42a and a large diameter portion 42b. A hole diameter of the large diameter portion 42b is larger than a hole diameter of the small diameter portion 42a. The small diameter portion 42a is located closer to the sealing plate 50 than the large diameter portion 42b is to the sealing plate 50.

The cylindrical portion 42 is connected to the shroud portion 43 via a diffuser wall 44 that extends annularly in a ring shape. Specifically, an inner peripheral surface of an end of the small diameter portion 42a of the cylindrical portion 42 is connected to an outer peripheral surface of an end of the shroud portion 43 via the diffuser wall 44 adjacent to the sealing plate 50. The diffuser wall 44 extends in the radial direction of the impeller shaft 12. The protruding length of the shroud portion 43 is shorter than the protruding length of the cylindrical portion 42 with respect to the diffuser wall 44. The small diameter portion 42a extends in a direction away from the diffuser wall 44 beyond a protruding end face 43f of the shroud portion 43.

The turbocharger 10 further has a compressor impeller chamber 45, a diffuser passage 46, and a compressor scroll passage 47. The compressor impeller chamber 45 accommodates the compressor impeller 13. The compressor scroll passage 47 extends in such a whirl as to extend around an outer periphery of the compressor impeller chamber 45. The diffuser passage 46 extends annularly to surround the compressor impeller 13. The compressor impeller chamber 45 is in communication with the compressor scroll passage 47 through the diffuser passage 46.

The compressor impeller chamber 45 is a space that is surrounded by an inner peripheral surface of the shroud portion 43 and the other surface of the sealing plate 50 oriented to the compressor housing 40 in a vicinity of the insertion hole 51. That is, the compressor impeller 13 is disposed inside the shroud portion 43. The compressor impeller 13 is accommodated in the compressor housing 40 and is configured to compress the intake gas introduced to the compressor impeller chamber 45. The inner peripheral surface of the shroud portion 43 has a shroud surface 43a that faces the compressor impeller 13.

The sealing plate 50 has a facing surface 53 that is a part of the other surface of the sealing plate 50 oriented to the compressor housing 40 and faces the diffuser wall 44 in the axial direction of the impeller shaft 12. The facing surface 53 extends annularly in a ring shape and is oriented substantially parallel to the diffuser wall 44. The diffuser passage 46 is formed between the diffuser wall 44 and the facing surface 53 in the axial direction of the impeller shaft 12. The facing surface 53 faces a diffuser surface 44a of the diffuser wall 44. The diffuser surface 44a is a part of the compressor housing 40, and is a wall surface of the compressor housing 40 that faces the diffuser passage 46. The diffuser surface 44a continues to the shroud surface 43a at an edge of the diffuser surface 44a on the compressor impeller chamber 45 side. The intake gas compressed by the compressor impeller 13 flows through the diffuser passage 46.

The compressor scroll passage 47 is defined by an inner bottom surface of the compressor housing 40 and the other surface of the sealing plate 50 that is oriented to the compressor housing 40. The intake gas is discharged to the compressor scroll passage 47 through the diffuser passage 46, and then, delivered to the internal combustion engine E through the compressor scroll passage 47.

As shown in FIG. 1, the compressor impeller 13 extends in the axial direction of the impeller shaft 12, and has a shaft insertion hole 13h through which the impeller shaft 12 is inserted. The first end part of the impeller shaft 12 protrudes into the compressor impeller chamber 45 in a state that the impeller shaft 12 is inserted through the shaft insertion hole 13h. The compressor impeller 13 is mounted to the impeller shaft 12 by a tool, for example, a nut 12a, such that the compressor impeller 13 is rotatable integrally with the impeller shaft 12 in a state that a part of the impeller shaft 12 protruding into the compressor impeller chamber 45 from the bearing housing 20 is inserted through the shaft insertion hole 13h. An end of the compressor impeller 13 adjacent to the bearing housing 20 is supported by the thrust bearing 16 via a seal ring collar 48 and a thrust collar 49. The thrust bearing 16 receives a thrust load that acts on the compressor impeller 13.

As shown in FIG. 2, the inner peripheral surface of the small diameter portion 42a of the cylindrical portion 42 of the compressor housing 40 is away from the outer peripheral surface of the shroud portion 43 at a distance corresponding to the extending length of the diffuser wall 44 between the inner peripheral surface of the small diameter portion 42a and the outer peripheral surface of the shroud portion 43 in the radial direction of the impeller shaft 12. The inner peripheral surface of the small diameter portion 42a of the cylindrical portion 42, the outer peripheral surface of the shroud portion 43, and a surface of the diffuser wall 44 that is opposite to the diffuser surface 44a cooperate to define an annular insertion recess 40a. Accordingly, the compressor housing 40 has the insertion recess 40a.

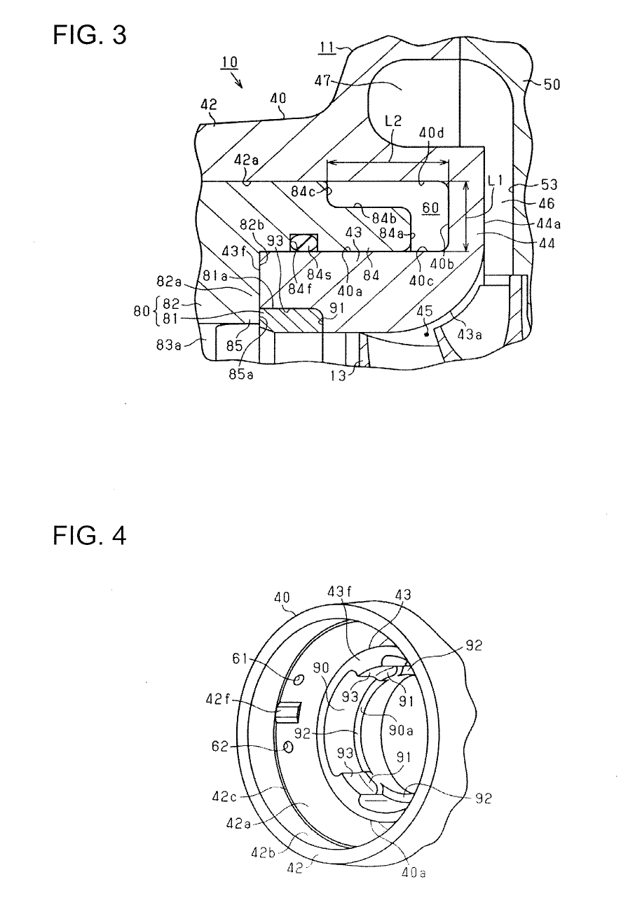

As shown in FIG. 3, the insertion recess 40a is defined by a bottom surface 40b, a first inner surface 40c, and a second inner surface 40d. The bottom surface 40b of the insertion recess 40a is formed by the surface of the diffuser wall 44 opposite to the diffuser surface 44a. The first inner surface 40c of the insertion recess 40a is formed by the outer peripheral surface of the shroud portion 43. The second inner surface 40d of the insertion recess 40a is formed by a part of the inner peripheral surface of the small diameter portion 42a of the cylindrical portion 42. In other words, the second inner surface 40d is located outward of the first inner surface 40c in a radial direction of the insertion recess 40a.

As shown in FIG. 2, the turbocharger 10 has a cooling passage 60 and a return passage 70. A fluid for cooling the diffuser surface 44a flows through the cooling passage 60. A passage forming member 80 is attached to the compressor housing 40 and cooperates with the compressor housing 40 to form the return passage 70. The passage forming member 80 includes a ring member 81 and a covering member 82.

The return passage 70 has a plurality of inlets 71, a plurality of outlets 72, and a plurality of communication passages 73. Each of the inlets 71 is connected to the corresponding outlet 72 through the communication passage 73. The ring member 81 of the passage forming member 80 cooperates with the compressor housing 40 to form the inlets 71 and the communication passages 73. The ring member 81 has a ring shape.

The covering member 82 is mounted to the compressor housing 40, and cooperates with the ring member 81 to form the outlets 72. The covering member 82 has a cylindrical shape. The covering member 82 is, in this embodiment, an aluminum die-cast part. The covering member 82 is inserted into the cylindrical portion 42 of the compressor housing 40. The covering member 82 includes a covering main body 83 and an insertion portion 84. The covering main body 83 of the covering member 82 has a cylindrical shape and has an intake 83a. The intake 83a extends in the axial direction of the impeller shaft 12 in the covering main body 83. An axis of the intake 83a corresponds to the axis of the impeller shaft 12.

The intake 83a is formed in the covering member 82, which is inserted into the cylindrical portion 42 of the compressor housing 40. In other words, the intake 83a is formed inside the cylindrical portion 42 of the compressor housing 40. Accordingly, the intake 83a is located upstream of the compressor impeller 13 in a flow direction of the intake gas in the compressor housing 40.

The insertion portion 84 has a cylindrical shape and is inserted into the insertion recess 40a. That is, the insertion recess 40a receives the insertion portion 84. The insertion portion 84 of the covering member 82 is a part of the passage forming member 80. A hole diameter of the insertion portion 84 is larger than a hole diameter of the covering main body 83 of the covering member 82, so that a step portion 82a is formed between an inner peripheral surface of the covering main body 83 and an inner peripheral surface of the insertion portion 84 in the covering member 82. The step portion 82a has a ring shape and is in contact with the protruding end face 43f of the shroud portion 43.

As shown in FIG. 3, the cooling passage 60 is formed by the insertion recess 40a and the insertion portion 84 inserted into the insertion recess 40a. The insertion portion 84 has a first extending surface 84a, a second extending surface 84b, and a third extending surface 84c. The first extending surface 84a is located away from the bottom surface 40b of the insertion recess 40a. The first extending surface 84a extends in an annular shape spreading outwardly from the first inner surface 40c of the insertion recess 40a in the radial direction of the insertion recess 40a and is oriented substantially parallel to the diffuser surface 44a. The second extending surface 84b defines a cylinder shape. The second extending surface 84b is perpendicular to an outer peripheral edge of the first extending surface 84a at one end edge of the second extending surface 84b, and extends in a direction away from the diffuser surface 44a. The third extending surface 84c continues to the other end edge of the second extending surface 84b that is opposite to the end edge of the second extending surface 84b intersecting with the first extending surface 84a, and spreads from the second extending surface 84b toward the second inner surface 40d of the insertion recess 40a.

The cooling passage 60 is defined by the first extending surface 84a, the second extending surface 84b, the third extending surface 84c, and the insertion recess 40a. The cooling passage 60 extends annularly in a loop. The length of the cooling passage 60 that extends along the bottom surface 40b of the insertion recess 40a is denoted by L1. The length of the cooling passage 60 that extends along the second inner surface 40d of the insertion recess 40a is denoted by L2. In this embodiment, the length L1 is shorter than the length L2.

As shown in FIG. 2, a mounting recess 83b has a circular shape and is formed in an outer peripheral surface of the covering main body 83. The mounting recess 83b receives a sealing member 83 s that is made of a rubber material and has a circular shape. The sealing member 83 s is disposed in close contact with the mounting recess 83b and an inner peripheral surface of the large diameter portion 42b of the cylindrical portion 42 of the compressor housing 40 to seal a gap between the outer peripheral surface of the covering main body 83 and the inner peripheral surface of the large diameter portion 42b. This configuration eliminates or minimizes leak of the fluid from the cooling passage 60 through the gap between the outer peripheral surface of the covering main body 83 and the inner peripheral surface of the large diameter portion 42b.

A mounting recess 84f has a circular shape and is formed in the inner peripheral surface of the insertion portion 84. The mounting recess 84f receives a sealing member 84s that is made of a rubber material and has a circular shape. The sealing member 84s is disposed in close contact with the mounting recess 84f and the outer peripheral surface of the shroud portion 43 to seal a gap between the inner peripheral surface of the insertion portion 84 and the outer peripheral surface of the shroud portion 43. This configuration eliminates or minimizes leak of the fluid from the cooling passage 60 through the gap between the inner peripheral surface of the insertion portion 84 and the outer peripheral surface of the shroud portion 43.

As shown in FIG. 4, the cylindrical portion 42 (i.e., the compressor housing 40) has a supply port 61 from which the fluid is supplied to the cooling passage 60 and a discharge port 62 from which the fluid is discharged after flowing through the cooling passage 60. The supply port 61 and the discharge port 62 open on the inner peripheral surface of the small diameter portion 42a. The supply port 61 and the discharge port 62 are located at positions that are opposite to the diffuser wall 44 with respect to the protruding end face 43f of the shroud portion 43 and adjacent to each other in a circumferential direction of the cylindrical portion 42 of the compressor housing 40.

A positioning groove 42f is formed in the inner peripheral surface of the small diameter portion 42a of the cylindrical portion 42 of the compressor housing 40. The positioning groove 42f is located between the supply port 61 and the discharge port 62 in the circumferential direction of the cylindrical portion 42. The positioning groove 42f extends in an axial direction of the cylindrical portion 42. An end of the positioning groove 42f adjacent to the large diameter portion 42b of the cylindrical portion 42 continues to a step portion 42c that is formed between the small diameter portion 42a and the large diameter portion 42b.

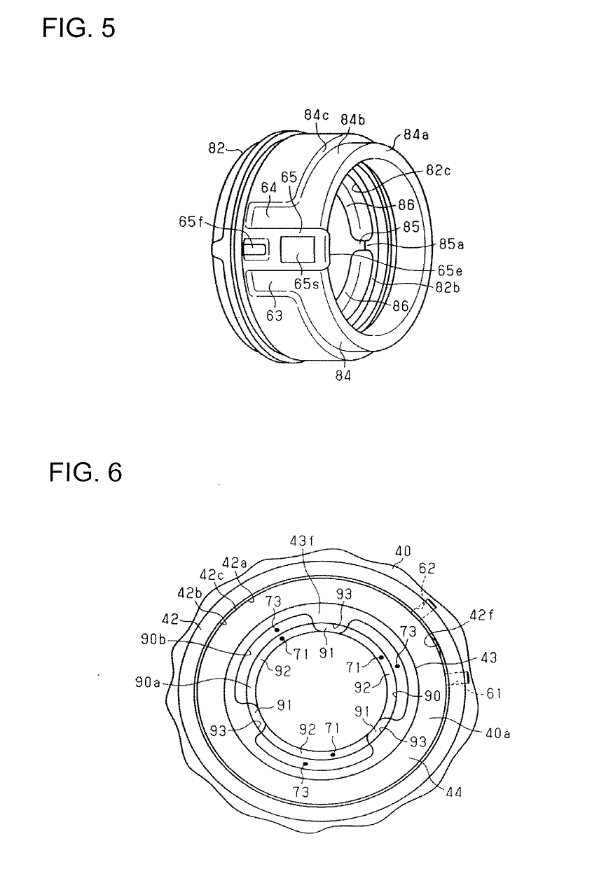

As shown in FIG. 5, a supply groove 63 and a discharge groove 64 are formed in an outer peripheral surface of the covering member 82 such that the supply groove 63 and the discharge groove 64 communicate with the supply port 61 and the discharge port 62, respectively. The supply groove 63 and the discharge groove 64 extend in an axial direction of the covering member 82. A bottom surface of the supply groove 63 has an overlap with the supply port 61 in a radial direction of the covering member 82 at an end of the supply groove 63, and continues to the second extending surface 84b of the insertion portion 84 at the other end of the supply groove 63. A bottom surface of the discharge groove 64 has an overlap with the discharge port 62 in the radial direction of the covering member 82 at an end of the discharge groove 64, and continues to the second extending surface 84b of the insertion portion 84 at the other end of the discharge groove 64.

A partition wall 65 is formed on the outer peripheral surface of the covering member 82, and extends in the axial direction of the covering member 82. The partition wall 65 is disposed between the supply groove 63 and the discharge groove 64 in a circumferential direction of the covering member 82 and separates the supply groove 63 from the discharge groove 64. The partition wall 65 has a distal end 65e on the first extending surface 84a side of the insertion portion 84, and protrudes beyond the first extending surface 84a. The distal end 65e of the partition wall 65 is in contact with the bottom surface 40b of the insertion recess 40a with the insertion portion 84 placed in the insertion recess 40a. An outer surface of the partition wall 65 extends along the inner peripheral surface of the small diameter portion 42a of the cylindrical portion 42 of the compressor housing 40. A sealing member 65s is disposed on the outer surface of the partition wall 65 to seal a gap between the outer surface of the partition wall 65 and the inner peripheral surface of the small diameter portion 42a of the cylindrical portion 42. The cooling passage 60 extends from the supply groove 63 to the discharge groove 64 in a circumferential direction of the insertion portion 84 away from the partition wall 65, and is in communication with the discharge groove 64.

The distal end 65e of the partition wall 65 contacts the bottom surface 40b of the insertion recess 40a. The sealing member 65s seals the gap between the outer surface of the partition wall 65 and the inner peripheral surface of the small diameter portion 42a. This configuration restrains the fluid, which is supplied from the supply port 61 and then flows through the supply groove 63, from passing through the partition wall 65 to enter the discharge groove 64. Accordingly, the fluid is supplied to the cooling passage 60 from the supply port 61 and through the supply groove 63. Then, the fluid flows through the cooling passage 60 in the circumferential direction of the insertion portion 84 away from the partition wall 65 to the discharge groove 64, and is discharged from the discharge port 62 through the discharge groove 64.

A projecting engagement portion 65f is formed on the outer surface of the partition wall 65 to be engaged with the positioning groove 42f. The projecting engagement portion 65f projects from the outer surface of the partition wall 65. The covering member 82 is placed inside the cylindrical portion 42 of the compressor housing 40 such that the projecting engagement portion 65f is engaged with the positioning groove 42f. The covering member 82 is positioned relative to the insertion recess 40a in the circumferential direction of the covering member 82 by the engagement of the projecting engagement portion 65f with the positioning groove 42f. That is, the covering member 82 has the projecting engagement portion 65f that serves as a positioning portion to position the covering member 82 relative to the insertion recess 40a in the circumferential direction of the covering member 82.

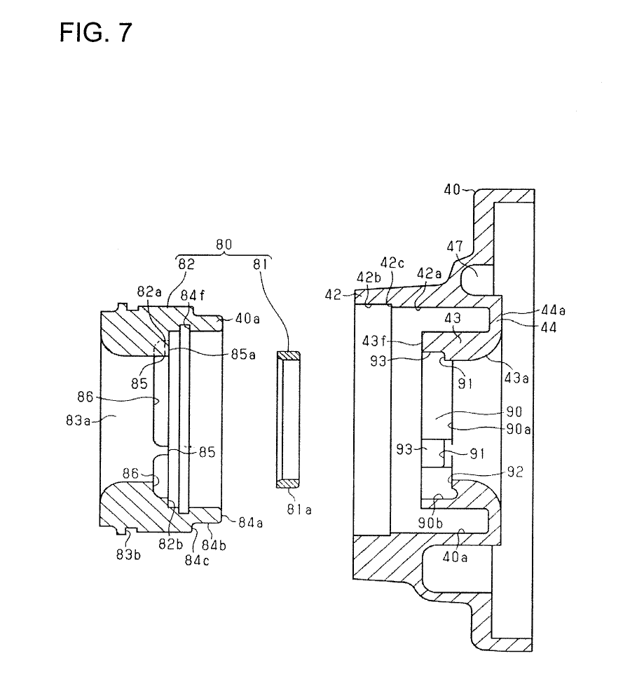

As shown in FIGS. 6 and 7, an accommodation depression 90 is formed in the inner peripheral surface of the shroud portion 43. The accommodation depression 90 has a round hole shape to accommodate the ring member 81. That is, the compressor housing 40 has the accommodation depression 90 that accommodates the ring member 81. An axis of the accommodation depression 90 corresponds to the axis of the shroud portion 43. A hole diameter of the accommodation depression 90 is larger than a hole diameter defined by an edge of the shroud surface 43a that is one of the edges of the shroud surface 43a away from the diffuser surface 44a as compared with the other edge of the shroud surface 43a. A bottom surface 90a of the accommodation depression 90 extends in the radial direction of the impeller shaft 12.

As shown in FIGS. 2 and 4, the bottom surface 90a of the accommodation depression 90 has a plurality of contact surfaces 91 and a plurality of inlet forming surfaces 92. The inlet forming surfaces 92 are located away from the ring member 81, and cooperate with the ring member 81 to form the inlets 71. The contact surfaces 91 are located between the ring member 81 and the inlet forming surfaces 92, and contact the ring member 81.

As shown in FIG. 6, the plurality of contact surfaces 91, specifically, in this embodiment, three contact surfaces 91 are spaced from each other in a circumferential direction of the accommodation depression 90. In this embodiment, the contact surfaces 91 are spaced at 120 degrees from each other in the circumferential direction of the accommodation depression 90. As viewed from an axial direction of the accommodation depression 90, the plurality of inlet forming surfaces 92, specifically, in this embodiment, three inlet forming surfaces 92 are arranged in the circumferential direction of the accommodation depression 90 such that each of the contact surfaces 91 is interposed between two adjacent inlet forming surfaces 92. That is, in this embodiment, the ring member 81 and the inlet forming surfaces 92 cooperate to form three inlets 71 in the circumferential direction of the accommodation depression 90.

In this embodiment, three press-fitting portions 93 in which the ring member 81 is press-fitted are formed on an inner peripheral surface 90b of the accommodation depression 90. Specifically, each of the three press-fitting portions 93 projects from the inner peripheral surface 90b of the accommodation depression 90 and continues to the corresponding contact surface 91. That is, the three press-fitting portions 93 are spaced from each other in the circumferential direction of the accommodation depression 90, in this embodiment, spaced at 120 degrees away from each other in the circumferential direction of the accommodation depression 90. Each of the press-fitting portions 93 has a contact surface (i.e., a press-fitting surface). The contact surface of the press-fitting portion 93 contacts an outer peripheral surface 81 a of the ring member 81, and has an arc-like shape that defines an imaginary circle with respect to the axis of the accommodation depression 90.

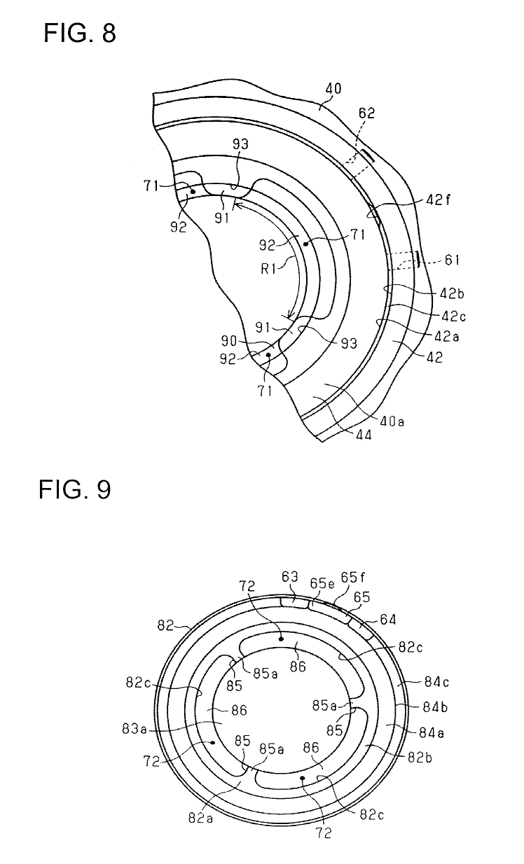

As shown in FIG. 8 and as viewed from the axial direction of the accommodation depression 90, the press-fitting portion 93 and the contact surface 91 are tapered inwardly in the radial direction of the accommodation depression 90. A length of a part of an inner peripheral edge of the accommodation depression 90 between any two adjacent contact surfaces 91 is denoted by R1 in FIG. 8. The length R1 is relatively short as compared with the case where the press-fitting portion 93 and the contact surface 91 are not tapered but extend inwardly in the radial direction of the accommodation depression 90 at a constant width. Each of the inlets 71, which is formed by the ring member 81 and the inlet forming surface 92, has a relatively large flow passage area at an entrance part of the inlet 71 that is located inward of the accommodation depression 90 in the radial direction of the accommodation depression 90 as compared with the case where the press-fitting portion 93 and the contact surface 91 are not tapered but extend inwardly in the radial direction of the accommodation depression 90 at a constant width.

As shown in FIG. 2, in a state that the ring member 81 is placed in the press-fitting portions 93 and is in contact with the contact surfaces 91, a surface of the ring member 81 opposite to each of the contact surfaces 91 is flush with the protruding end face 43f of the shroud portion 43 in the radial direction of the impeller shaft 12. The plurality of communication passages 73 is formed between the inner peripheral surface 90b of the accommodation depression 90 and the outer peripheral surface 81 a of the ring member 81. As shown in FIG. 6, the plurality of communication passages 73, specifically, in this embodiment, three communication passages 73 are arranged in the circumferential direction of the accommodation depression 90, and each of the press-fitting portions 93 is interposed between two adjacent communication passages 73 in the circumferential direction of the accommodation depression 90.

As shown in FIGS. 2 and 9, the covering member 82 has a plurality of falling prevention portions 85 and a plurality of outlet forming surfaces 86. The falling prevention portions 85 are located between the ring member 81 and the outlet forming surfaces 86, and contact the ring member 81 fitted in the accommodation depression 90 to prevent the ring member 81 from falling off the accommodation depression 90. The outlet forming surfaces 86 are located away from the ring member 81, and cooperate with the ring member 81 to form the outlets 72. The falling prevention portion 85 and the outlet forming surface 86 are formed in the step portion 82a that is formed between the inner peripheral surface of the covering main body 83 and the inner peripheral surface of the insertion portion 84.

As shown in FIG. 9, an end face 85a of the falling prevention portion 85 contacts the ring member 81. An end face 82b of the step portion 82a contacts the protruding end face 43f of the shroud portion 43. The end face 85a of the falling prevention portion 85 continues to the end face 82b of the step portion 82a. The covering member 82 has the plurality of falling prevention portions 85, specifically, in this embodiment, three falling prevention portions 85. The three falling prevention portions 85 are spaced from each other in the circumferential direction of the covering member 82. That is, the falling prevention portions 85 are spaced from each other in the covering member 82 in a circumferential direction of the ring member 81. In this embodiment, the three falling prevention portions 85 are spaced at 120 degrees away from each other in the circumferential direction of the covering member 82.

As viewed from the axial direction of the covering member 82, the plurality of outlet forming surfaces 86, specifically, in this embodiment, three outlet forming surfaces 86 are arranged in the circumferential direction of the covering member 82. Each of the falling prevention portions 85 is interposed between two adjacent outlet forming surfaces 86. Accordingly, the outlet forming surfaces 86 (i.e., the covering member 82) and the ring member 81 cooperate to form three outlets 72 that are arranged in the circumferential direction of the covering member 82. That is, each of the falling prevention portions 85 is interposed between two adjacent outlets 72 in the circumferential direction of the ring member 81.

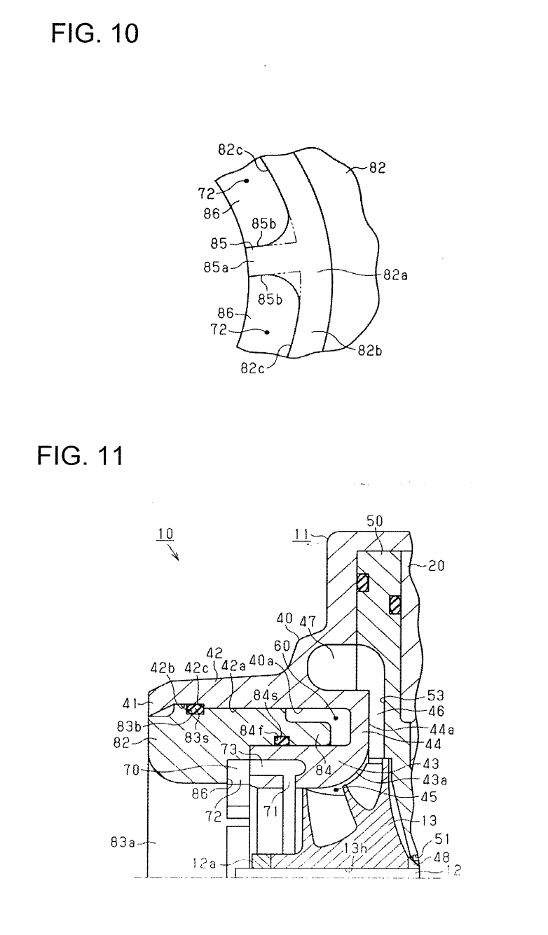

As shown in FIG. 10, the falling prevention portion 85 has a wall surface 85b at each of the opposite sides of the falling prevention portion 85. The wall surfaces 85b are arranged in the circumferential direction of the ring member 81, and each of the wall surfaces 85b faces its corresponding outlet 72. As viewed from the axial direction of the covering member 82, the falling prevention portion 85 is tapered inwardly in the radial direction of the covering member 82. Each of the falling prevention portions 85 is interposed between two adjacent outlet forming surfaces 86 in the circumferential direction of the ring member 81. Each of the wall surfaces 85b continues to an inner peripheral surface 82c through which the end face 82b of the step portion 82a is connected to the outlet forming surface 86. Each of the wall surfaces 85b of the falling prevention portion 85 extends from the corresponding inner peripheral surface 82c in a curve such that the wall surfaces 85b approach each other inwardly in the radial direction of the covering member 82.

As shown in FIG. 2, the covering member 82 is placed inside the cylindrical portion 42 of the compressor housing 40 such that each of the falling prevention portions 85 overlaps the corresponding press-fitting portion 93 and the corresponding contact surface 91 in the axial direction of the impeller shaft 12. This configuration allows communication between the inlet 71, the communication passage 73, and the outlet 72.

The inlet 71 of the return passage 70 is formed in communication with the compressor impeller chamber 45, and the outlet 72 of the return passage 70 is formed in communication with the intake 83a. The intake 83a is located upstream of the compressor impeller 13 in the flow direction of the intake gas in the compressor housing 40. A part of the intake gas, which is introduced to the compressor housing 40 and then introduced to the compressor impeller chamber 45 by the rotation of the compressor impeller 13, returns to the intake 83a through the return passage 70 in the compressor housing 40.

The ring member 81 is press-fitted in the press-fitting portion 93. Accordingly, the ring member 81 cooperates with each of the inlet forming surfaces 92 to form the inlet 71, and the communication passage 73 is formed between the inner peripheral surface 90b of the accommodation depression 90 and the outer peripheral surface 81 a of the ring member 81. The cylindrical portion 42 has a swage portion 41 at a distal end of the cylindrical portion 42. The swage portion 41 is formed such that the distal end of the cylindrical portion 42 is deformed toward the covering member 82. The swage portion 41 is swaged on the outer peripheral surface of the covering member 82 with the covering member 82 placed inside the cylindrical portion 42 of the compressor housing 40, so that the covering member 82 is mounted to the compressor housing 40. By the mounting of the covering member 82 to the compressor housing 40, the ring member 81 and each of the outlet forming surfaces 86 cooperate to form the outlet 72, and each of the falling prevention portions 85 contacts the ring member 81 to prevent the ring member 81 from falling off the accommodation depression 90.

The following describes the operation of the turbocharger 10 according to this embodiment.

The exhaust gas emitted from the internal combustion engine E flows through the turbine scroll passage 35 and the communication passage 34 to the turbine chamber 33. The exhaust gas that flows into the turbine chamber 33 rotates the turbine impeller 14 in the turbine chamber 33. The rotation of the turbine impeller 14 rotates the compressor impeller 13 integrally with the turbine impeller 14 through the impeller shaft 12. The rotation of the compressor impeller 13 compresses the intake gas that is introduced to the compressor impeller chamber 45 from the intake 83a. The velocity of the compressed intake gas is slowed and converted into the pressure energy while the intake gas flows through the diffuser passage 46. The highly-compressed intake gas is discharged to the compressor scroll passage 47 and delivered to the internal combustion engine E. This configuration increases the intake efficiency and the performance of the internal combustion engine E.

In the compressor housing 40, the diffuser surface 44a that faces the diffuser passage 46 is heated by the intake gas, which is compressed by the rotation of the compressor impeller 13, flowing through the diffuser passage 46. However, the diffuser wall 44 is cooled by the fluid that flows through the cooling passage 60. This suppresses the heating of the diffuser surface 44a.

Additionally, a part of the intake gas, which is introduced to the compressor housing 40 and then introduced to the compressor impeller chamber 45 by the rotation of the compressor impeller 13, returns through the return passage 70 to the intake 83a, which is located upstream of the compressor impeller 13 in the flow direction of the intake gas in the compressor housing 40. This reduces occurrence of surging even if the flow rate of the intake gas introduced to the compressor housing 40 decreases.

The above-described embodiment offers the following effects.

(1) The passage forming member 80 attached to the compressor housing 40 cooperates with the compressor housing 40 to form the return passage 70. A part of the intake gas, which is introduced to the compressor housing 40, returns through the return passage 70 to the upstream side of the compressor impeller 13 in the flow direction of the intake gas in the compressor housing 40. This reduces occurrence of surging even if the flow rate of the intake gas introduced to the compressor housing 40 decreases. The cooling passage 60 is formed solely by the attachment of the passage forming member 80 to the compressor housing 40 in a state that the insertion portion 84, which is a part of the passage forming member 80 that forms the return passage 70, is placed in the insertion recess 40a of the compressor housing 40. Accordingly, the compressor housing 40 does not need to be formed in a complex mold using a core cylinder, unlike the case where the cooling passage 60 is formed within a wall portion of the compressor housing 40. Therefore, this embodiment reduces occurrence of surging and facilitates making of the cooling passage 60.

(2) The cooling passage 60 is defined by the first extending surface 84a, the second extending surface 84b, the third extending surface 84c, and the insertion recess 40a, so that a part of the cooling passage 60 extends in a direction away from the diffuser surface 44a. This configuration enables a flow passage area of the cooling passage 60 to be increased, for example, as compared with the case where the cooling passage 60 is defined by the first extending surface 84a and the insertion recess 40a.

The fluid that flows through the cooling passage 60 is heated by cooling of the diffuser surface 44a. If a part of the cooling passage 60 extends in the direction away from the diffuser surface 44a, the intake gas that flows on the upstream side of the compressor impeller 13 in the flow direction of the intake gas in the compressor housing 40 may be heated by the fluid that flows through the cooling passage 60. However, in this embodiment, the cooling passage 60 is defined by the first extending surface 84a, the second extending surface 84b, the third extending surface 84c, and the insertion recess 40a. This configuration allows keeping the cooling passage 60 away from the compressor impeller 13 while increasing the flow passage area of the cooling passage 60 as much as possible. Accordingly, this configuration cools the diffuser surface 44a efficiently while restraining the fluid that flows through the cooling passage 60 from heating the intake gas that flows on the upstream side of the compressor impeller 13 in the flow direction of the intake gas in the compressor housing 40.

(3) The passage forming member 80 includes the ring member 81 and the covering member 82. This configuration enables the return passage 70 to be formed solely by the attachment of the ring member 81 and the covering member 82 to the compressor housing 40. Accordingly, this configuration facilitates manufacturing of the compressor housing 40, for example, as compared with the case where both the inlet 71 and the communication passage 73 of the return passage 70 are formed by the compressor housing 40 only.

(4) The supply groove 63, the discharge groove 64, and the partition wall 65 are formed in the outer peripheral surface of the covering member 82. The cooling passage 60 extends from the supply groove 63 to the discharge groove 64 in the circumferential direction of the insertion portion 84 away from the partition wall 65. The covering member 82 has the projecting engagement portion 65f that serves as a positioning portion to position the covering member 82 relative to the insertion recess 40a in the circumferential direction of the covering member 82. The fluid is supplied to the cooling passage 60 from the supply port 61 through the supply groove 63. Then, the fluid flows through the cooling passage 60 in the circumferential direction of the insertion portion 84 away from the partition wall 65 to the discharge groove 64, and is discharged from the discharge port 62 through the discharge groove 64. This enables the fluid to flow in the circumferential direction of the insertion portion 84 efficiently, so that the fluid cools the diffuser surface 44a efficiently. Further, the covering member 82 is positioned relative to the insertion recess 40a in the circumferential direction of the covering member 82 by the engagement of the projecting engagement portion 65f with the positioning groove 42f. This eliminates or minimizes deviation in positioning between the supply port 61 and the supply groove 63 and in positioning between the discharge port 62 and the discharge groove 64.

(5) The ring member 81 is press-fitted in the press-fitting portion 93. Accordingly, the ring member 81 cooperates with each of the inlet forming surfaces 92 to form the inlet 71, and the communication passage 73 is formed between the inner peripheral surface 90b of the accommodation depression 90 and the outer peripheral surface 81 a of the ring member 81. The covering member 82 is mounted to the compressor housing 40. By the mounting of the covering member 82 to the compressor housing 40, the ring member 81 and each of the outlet forming surfaces 86 cooperate to form the outlet 72, and each of the falling prevention portions 85 contacts the ring member 81 to prevent the ring member 81 from falling off the accommodation depression 90. This configuration enables the return passage 70 to be formed solely by the press-fit of the ring member 81 in the press-fitting portion 93 and the attachment of the covering member 82 to the compressor housing 40, thereby facilitating making of the return passage 70.

(6) Each of the falling prevention portions 85 is interposed between two adjacent outlets 72 in the circumferential direction of the ring member 81. The wall surfaces 85b of the falling prevention portions 85 are arranged in the circumferential direction of the ring member 81. That is, the wall surfaces 85b of each falling prevention portion 85 are arranged in the circumferential direction of the ring member 81. The wall surfaces 85b of each falling prevention portion 85, which are respectively disposed at the opposite sides of each falling prevention portion 85, faces its corresponding outlet 72. In this configuration, if the intake gas flows into the outlet 72 in a whirl through the communication passage 73, the whirling flow of the intake gas bumps into the wall surface 85b of the falling prevention portion 85 and is blocked by the wall surface 85b. Accordingly, this configuration restrains the whirling intake gas from returning to the upstream side of the compressor impeller 13 in the flow direction of the intake gas in the compressor housing 40. Thus, this configuration reduces noise and vibration that may be caused by the interference between the intake gas returned through the return passage 70 and the intake gas to be introduced to the compressor housing 40.

(7) Each of the wall surfaces 85b of the falling prevention portion 85 extends from the inner peripheral surfaces 82c in a curve such that the wall surfaces 85b approach each other inwardly in the radial direction of the covering member 82. For example, as indicated by the two dot chain line in FIG. 10 and viewed from the axial direction of the covering member 82, if a sharp corner is defined by each of the inner peripheral surface 82c and the wall surface 85b extending from the inner peripheral surface 82c, the intake gas may bump into the sharp corner and whirl in the reverse direction. However, the turbocharger 10 according to the above-described embodiment eliminates or minimizes occurrence of this problem.

(8) Each of the inlets 71 has a large flow passage area at the entrance part of the inlet 71 that is located inward of the accommodation depression 90 in the radial direction of the accommodation depression 90 as compared with the case where the press-fitting portion 93 and the contact surface 91 are not tapered but extend inwardly in the radial direction of the accommodation depression 90 at a constant width. This configuration allows a part of the intake gas, which is introduced to the compressor housing 40 and then introduced to the compressor impeller chamber 45 by the rotation of the compressor impeller 13, to flow into the inlet 71 easily. Accordingly, this configuration allows a part of the intake gas, which is introduced to the compressor impeller chamber 45 by the rotation of the compressor impeller 13, to return smoothly through the return passage 70 to the intake 83a that is located upstream of the compressor impeller 13 in the flow direction of the intake gas in the compressor housing 40.

(9) This embodiment does not require additional processing for making the inlet 71 in the compressor housing 40 after the compressor housing 40 is manufactured, such as the case where the inlet 71 of the return passage 70 is formed in the compressor housing 40. Accordingly, the return passage 70 is formed easily.

(10) The compressor housing 40 can be manufactured by aluminum die casting. Accordingly, the compressor housing 40 does not need to be formed in a complex mold using a core cylinder. Accordingly, the manufacturing cost can be reduced.

(11) The diffuser wall 44 is cooled by the fluid that flows through the cooling passage 60. This suppresses heating of the diffuser surface 44a. Thus, this suppresses coking of oil on the diffuser surface 44a even if the intake gas contains oil, thereby eliminating or minimizing a problem that the built up coked oil may reduce a section area of the diffuser passage 46 and may block the delivery of the intake gas to the internal combustion engine E by the turbocharger 10.

(12) The above-described embodiment reduces occurrence of surging even if the flow rate of the intake gas introduced to the compressor housing 40 decreases, thereby increasing the operation area of the turbocharger 10 in a state that the flow rate of the intake gas introduced to the compressor housing 40 is low.

The above-described embodiment may be modified as below.

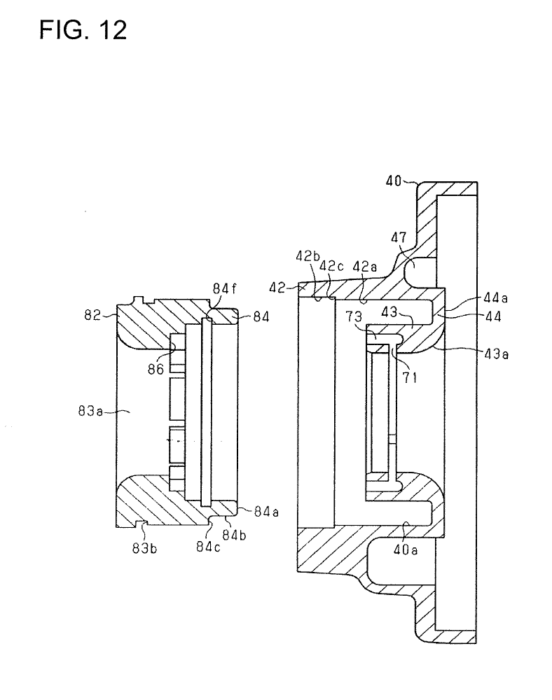

As shown in FIGS. 11 and 12, the turbocharger 10 does not necessarily have to include the ring member 81. The compressor housing 40 may form both the inlet 71 and the communication passage 73 of the return passage 70 without cooperating with the ring member 81. The passage forming member 80 does not necessarily have to include the ring member 81 and may include the covering member 82 only. Accordingly, the compressor housing 40 may cooperate with the covering member 82 to form the outlet 72 such that the outlet 72 may be formed solely by the attachment of the covering member 82, as the passage forming member 80, to the compressor housing 40. This configuration reduces the number of parts necessary for the turbocharger 10.

In the above-described embodiment, the fluid is supplied to the cooling passage 60 from the supply port 61 through the supply groove 63. Then, the fluid flows through the cooling passage 60 in the circumferential direction of the insertion portion 84 away from the partition wall 65 to the discharge groove 64, and is discharged from the discharge port 62 through the discharge groove 64. However, the fluid does not necessarily have to flow through the cooling passage 60 in this manner as long as the diffuser surface 44a is cooled by the fluid flowing through the cooling passage 60.

In the above-described embodiment, the cooling passage 60 may be defined, for example, by the first extending surface 84a and the insertion recess 40a.

In the above-described embodiment, the second extending surface 84b may define a cylindrical shape such that the second extending surface 84b intersects obliquely with the outer peripheral edge of the first extending surface 84a at one end edge of the second extending surface 84b and extends in the direction away from the diffuser surface 44a. That is, the second extending surface 84b defines a cylindrical shape such that the second extending surface 84b only has to intersect with the outer peripheral edge of the first extending surface 84a and extends in the direction away from the diffuser surface 44a.

In the above-described embodiment, the length L1 of the cooling passage 60, which extends along the bottom surface 40b of the insertion recess 40a, may be longer than the length L2 of the cooling passage 60, which extends along the second inner surface 40d of the insertion recess 40a.

In the above-described embodiment, the length L1 of the cooling passage 60, which extends along the bottom surface 40b of the insertion recess 40a, may be substantially equal to the length L2 of the cooling passage 60, which extends along the second inner surface 40d of the insertion recess 40a.

In the above-described embodiment, as viewed from the axial direction of the accommodation depression 90, the press-fitting portion 93 and the contact surface 91 may extend inwardly in the radial direction of the accommodation depression 90 at a constant width.

In the above-described embodiment, the wall surfaces 85b of the falling prevention portion 85, which are arranged in the circumferential direction of the ring member 81, do not necessarily have to face the outlets 72.

In the above-described embodiment, the number of the falling prevention portions 85 is not limited to three, and may be one, two, or more than three.

In the above-described embodiment, the positioning groove 42f, which is formed in the inner peripheral surface of the small diameter portion 42a of the compressor housing 40, does not necessarily have to be located between the supply port 61 and the discharge port 62 in the circumferential direction of the cylindrical portion 42. The projecting engagement portion 65f, which is engaged with the positioning groove 42f, has to be formed in the outer peripheral surface of the covering member 82, but does not necessarily have to be formed in the outer surface of the partition wall 65.

What is claimed is:

1. A turbocharger comprising:
a compressor housing configured to receive an intake gas to be delivered to an internal combustion engine;
a compressor impeller accommodated in the compressor housing and configured to compress the intake gas;
a diffuser passage through which the intake gas compressed by the compressor impeller flows, the diffuser passage extending annularly to surround the compressor impeller;
a diffuser surface that is a part of the compressor housing, the diffuser surface being a wall surface of the compressor housing that faces the diffuser passage;
a cooling passage through which a fluid for cooling the diffuser surface flows; and
a return passage through which a part of the intake gas returns to an upstream side of the compressor impeller in a flow direction of the intake gas in the compressor housing, wherein
a passage forming member is attached to the compressor housing, and cooperates with the compressor housing to form the return passage,
the compressor housing has an insertion recess that has a circular shape,
the insertion recess receives an insertion portion that is a part of the passage forming member and has a cylindrical shape, and
the cooling passage is formed by the insertion recess and the insertion portion inserted into the insertion recess.

2. The turbocharger according to claim 1, wherein
the insertion portion has a first extending surface, a second extending surface, and a third extending surface,
the first extending surface is located away from a bottom surface of the insertion recess, extends in an annular shape spreading outwardly from a first inner surface of the insertion recess in a radial direction of the insertion recess, and is oriented substantially parallel to the diffuser surface,
the second extending surface defines a cylinder shape, intersects with an outer peripheral edge of the first extending surface at one end edge of the second extending surface, and extends in a direction away from the diffuser surface,
the third extending surface continues to the other end edge of the second extending surface that is opposite to the end edge of the second extending surface intersecting with the first extending surface, and spreads from the second extending surface toward a second inner surface of the insertion recess that is located outward of the first inner surface in the radial direction of the insertion recess, and
the cooling passage is defined by the first extending surface, the second extending surface, the third extending surface, and the insertion recess.

3. The turbocharger according to claim 1, wherein
the passage forming member includes a ring member and a covering member,
the return passage has an inlet, an outlet, and a communication passage through which the inlet is connected to the outlet,
the ring member cooperates with the compressor housing to form the inlet and the communication passage, and
the covering member cooperates with the ring member to form the outlet, and the covering member has a cylindrical shape and includes the insertion portion.

4. The turbocharger according to claim 3, wherein
the compressor housing has a supply port from which the fluid is supplied to the cooling passage and a discharge port from which the fluid is discharged after flowing through the cooling passage,
a supply groove and a discharge groove are formed in an outer peripheral surface of the covering member, and communicate with the supply port and the discharge port, respectively,
a partition wall is formed on the outer peripheral surface of the covering member and separates the supply groove from the discharge groove,
the cooling passage extends from the supply groove to the discharge groove in a circumferential direction of the insertion portion away from the partition wall, and is in communication with the discharge groove, and
the covering member has a positioning portion to position the covering member relative to the insertion recess in a circumferential direction of the covering member.
